(19) United States
(12) Patent Application Publication
(10) Pub. No.: US 2009/0071555 A1
(43) Pub. Date: Mar. 19, 2009

(54) Integrated technological system for improving the climate

(76) Inventor: Michal Kravcik, Kosice (SK)

Correspondence Address: DONN K. HARMS;PATENT & TRADEMARK LAW CENTER, SUITE 100, 12702 VIA CORTINA, DEL MAR, CA, 92014, US

(21) Appl. No.: 12/284,030

(22) Filed: Sep. 17, 2008

(30) Foreign Application Priority Data
Sep. 17, 2007 (SK) PUV 159-2007

(51) Int. Cl. E03B 11/00; A01G 15/00

(52) U.S. Cl. 137/561 R; 239/14.1

(57) ABSTRACT

An integrated technological system for improving the climate is disclosed providing integrated management especially in the area of water. The system provides management and improvement in the area of integrated management of water sources, replenishment of water into the water cycle, water policy, and flood prevention with an additional contribution towards all areas of life and development of a society.

### TECHNICAL AREA

The technical solution is related to an integrated technological system for improving the climate, mainly in the area of integrated management of water sources, replenishment of water into the water cycle, water policy and flood prevention with an additional contribution towards all areas of life and development of society.

### Technical Status to Date

Several decades ago, a water shortage as well as a sudden change of climate was hardly imaginable. However, in recent years, mankind have reached such a level of development which has consciously or unconsciously changed the water cycle on an unprecedented scale. Deforestation, agricultural and urban activities, during which the character of vegetation has changed, has caused erosion of the soil. Therefore, people have unconsciously changed the flows of a large volume of water and energy. The water cycle and temperature regime significantly influences the amount of evaporated water and from the total amount of solar energy which reaches earth, approximately 30% is reflected back to space, approximately 47% is radiated as thermal radiation and 23% forms part of the water circulation during evaporation. If solar radiation falls onto a dry area, approximately 70-80% of solar energy is turned into heat and if solar radiation falls on an area well stocked with water, 70-80% of solar energy forms vapor. Water areas can use around 90% of solar energy for evaporation.

At present, there are various systems for holding water which are based on the building of water reservoirs, which balance the water regime of rivers and this water is further used for the population, industry, production of energy and foodstuffs. A disadvantage of this system is that it does not resolve the problem of water shortages in the ecosystem and does not stabilize the water regime.

Another well known technical solution applied in areas with water shortages are Rain Water Harvesting systems for the collection of rainwater for the same purpose. In this case, water reservoirs are small water reservoirs in the countryside which collect rainwater to be further used. A disadvantage of these systems is that they are not able to stabilize the water balance during floods and in the water cycle to reach a regular, sufficient volume of water for sustainable development.

Another well known solution is described in Slovak Patent Document No. 279 716 named Supporting, Lifting and Stabilizing Water Engineering Constructions and the Method of Their Construction, where the construction of water engineering buildings such as supporting and stabilizing surfaces for sanitation of ravines under dams and chutes, stabilizing thresholds and lifting dams in river channels of grainy material or above water, as well as grainy areas supported by flexible bases are dimensionally adjusted to the size of grains, so the flowing water will fill them with grains, creating flexible support of the surface or dam. A disadvantage of this solution is that it is not able to stabilize the water balance during floods and in the water cycle.

Another well known solution is described in Czech Patent Document No. 297 401 named Anti-flood barrier, which is made from a line of vertical stabilizing pillars between which, in a vertical direction, there is at least one line of anti-flood panels and in the terrain base, there is a reinforced concrete foundation in which there are vertical stabilizing pillars at determined distances. Next to these stabilizing pillars, from the flood side in the reinforced concrete foundation, there is a threshold whilst the bottom edge of each anti-flood panel of the basic line is equipped with flexible rubber horizontal sealing band whose inner abutting area is fitted with grooves and whose side parts hold the horizontal sealing band to the anti-flood panels, which have assembly openings on their sides. Between the stabilization pillar and connection of neighboring anti-flood panels, a pressure band is fitted to the stabilization pillar with a vertical elastic sealing band and the anti-flood panels are fitted to the stabilizing pillars via stirrups which pass through the assembly openings of the neighboring anti-flood panels. A disadvantage of this solution is that it is not able to stabilize the water balance during floods and in the water cycle.

Another well known solution is described in Czech Patent Document No. 298 180 named Method of Building an Anti-flood System where, in accordance with the hydro-technical model of flood-protection, firstly in the center of the threatened area at least one preparation station with a control room is created, in which protective sealing equipment and their components are prepared, mainly large volume sacks and filling mixture. These are later transferred to the threatened water banks to build or reinforce the protective dam. A disadvantage of this solution is that it is not able to stabilize the water balance during floods and in the water cycle.

Another well known solution is described in Slovak Patent Document No. 284 090 with priority given to South African patent application Nos. 95/10608 and 96/8693 named Equipment and Method of Desalting Water, which is formed by a casing and filtration element which is placed in the mentioned casing and contains reverse osmotic membranes forming salt retention channels, a pump for pumping desalted water into the filtration element and a partition placed inside the casing between the pump and filtration element in the direction of water flow. The partition, which is in the form of a circular disk, includes a number of openings in the circular cross cut with various diameters for the creation of individual water currents of various diameters. Therefore, when the water flows through the openings in the partition, the water current has a turbulent nature with a decrease in pressure behind the partition, so gases diluted in water are released from the solution in the form of bubbles which are dragged by the flowing water in the direction away from the partition. The equipment is adjusted for the inflow of individual water flows into the retention salt channels and is adjusted for the inflow of water with bubbles to the mentioned salt retention channels of the filtration element at lower pressure and in the form of turbulent flows in comparison with the flow in front of the partition. A disadvantage of this solution is that it is not able to stabilize the water balance during floods and in the water cycle.

### Basis of the Technical Solution

The mentioned disadvantages are considerably eliminated by an integrated technological system for improving the climate, in accordance with technical solutions whose basis is that it is created by one water reservoir block which is connected to at least one bio-technical treatment block and/or to at least one technical treatment block. This is connected on one side to at least one seepage technical block which is connected to at least one absorption technical block. On the other side, it is connected to at least one drainage technical block and on the third side, it is connected to at least one evaporation technical block which is connected to a water reservoir block. At the same time, at least one bio-technical treatment block is connected on one side to at least one bio-technical seepage block which is connected to at least one bio-technical absorption block and, on the other side, is connected to at least one bio-technical drainage block and on the third side, it is connected to at least one bio-technical evaporation block which is connected to the water reservoir block.

It is advantageous that at least one technical treatment block is connected to at least one bio-technical treatment block.

### PREVIEW OF THE PICTURES ON THE DRAWING

The technical solution will be closely explained using drawings where picture No. 1 shows the integrated technological system for improving the climate.

### EXAMPLES OF IMPLEMENTATION

### Example No. 1

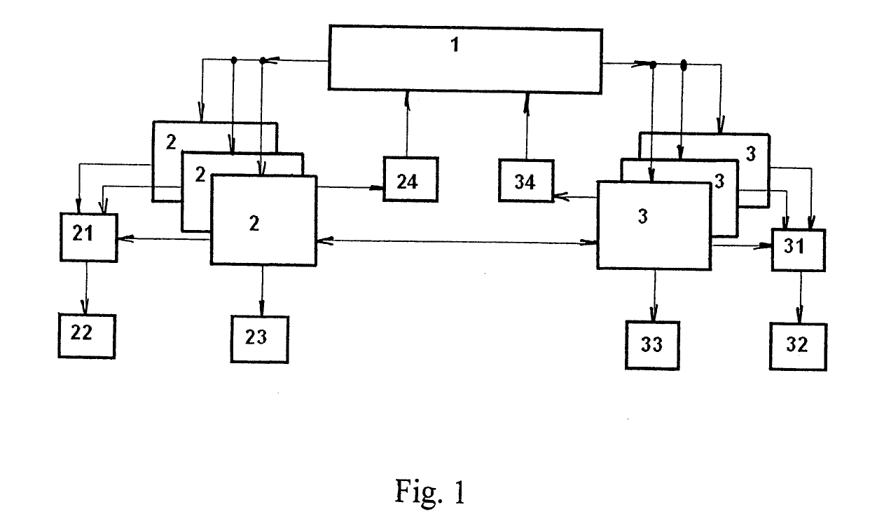

Integrated technological system for improving the climate, shown in FIG. 1, is created by a water reservoir block 1, which are clouds. Water reservoir block 1 is connected to one technical treatment block 2, which are small contour dams collecting fallen rainwater and surface drained water. Technical treatment block 2 is connected to one technical seepage block 21, which provides seepage of water through the soil. Technical seepage block 21 is further connected to a technical absorption block 22, which provides seepage and retention of fallen rainwater and non-drained surface drainage water in the soil. Technical treatment block 2 is further connected to technical drainage block 23, which provides surface drainage of uncollected fallen rainwater and uncollected surface drainage water. Technical treatment block 2 is further connected to one technical evaporation block 24, which provides evaporation of fallen rainwater and surface drainage water. Technical evaporation block 24 is further connected to one water reservoir block 1.

### Example No. 2

Integrated technological system for improving the climate, shown in FIG. 1, is created by a water reservoir block 1, which are clouds. Water reservoir block 1 is connected to one technical treatment block 3, which are grass strips, collecting fallen rainwater and surface drainage water. Bio-technical treatment block 3 is connected to one bio-technical seepage block 31, which provides seepage of water through the soil. Bio-technical seepage block 31 is further connected to biotechnical absorption block 32, which provides seepage and retention of fallen rainwater and non-drained surface drainage water in the soil. Bio-technical treatment block 3 is further connected to bio-technical drainage block 33, which provides surface drainage of uncollected fallen rainwater and uncollected surface drainage water. Bio-technical treatment block 3 is further connected to one bio-technical evaporation block 34, which provides evaporation of fallen rainwater and surface drainage water. Bio-technical evaporation block 34 is further connected to one water reservoir block 1.

### Example No. 3

Integrated technological system for improving the climate, shown in FIG. 1, is created by a water reservoir block 1, which are clouds. Water reservoir block 1 is connected to one technical treatment block 2, which are water retaining terraces, collecting the fallen rainwater and surface drainage water. Technical treatment block 2 is connected to one technical seepage block 21, which provides seepage of water. Technical seepage block 21 is further connected to a technical absorption block 22, which provides seepage and retention of fallen rainwater and non-drained surface drainage water. Technical treatment block 2 is further connected to technical drainage block 23, which provides surface drainage of uncollected fallen rainwater and uncollected surface drainage water. Technical treatment block 2 is further connected to one technical evaporation block 24, which provides evaporation of fallen rainwater and surface drainage water. Technical evaporation block 24 is further connected to one water reservoir block 1. Technical treatment block 2 is further connected to one bio-technical block 3, which are rows of bushes which collect fallen rainwater and surface drainage water. Bio-technical treatment block 3 is connected to one bio-technical seepage block 31, which provides seepage of water. Bio-technical seepage block 31 is further connected to bio-technical absorption block 32, which provides absorption and retention of fallen rainwater and non-drained surface drainage water. Biotechnical treatment block 3 is further connected to bio-technical drainage block 33, which provides surface drainage of uncollected fallen rainwater and uncollected surface drainage water. Bio-technical treatment block 3 is further connected to one bio-technical evaporation block 34, which provides evaporation of fallen water and surface drainage water. Bio-technical evaporation block 34 is further connected to one water reservoir block 1.

### INDUSTRIAL APPLICATION

The integrated technological system in accordance with the technical solution which is at least seven times cheaper compared to classical solutions can be used for replenishing stocks of underground water and therefore improving the hydrological regime of rivers and streams, creating water resources, protecting the environment against drought, fires and floods, renewal of bio-diversity, stabilization of the climate and alleviating the effects of changing weather. The use of a technical solution in particular conditions of rivers and streams with a disturbed water regime will provide renewal of a stable water regime within 5 to 10 years and saturation of the water cycle in the region to achieve a more regular occurrence of rain and soil saturation as well as increase the stock of underground water. Wide use of this technical solution in dry countries around the world will provide the change of a dry and yellow country into a green country rich in water with rejuvenated soil production potential. Use of the technical solution will ensure strengthening of global safety and prevention of global climatic changes. The use of this technical solution will also have a positive influence upon the water balance of an area in which it is applied as an increase in the amount of water in the water cycle of an area is accompanied by a decrease in extreme demonstrations of weather by an optimal level of rainfall. Application of this technical solution focuses upon the field of protection of an area against floods, provides protection to the area during floods, flood prevention and protection of the area against drought and safety measures during periods of drought and preventative measures against drought, therefore widespread maintenance of the countryside and the soil in good condition, which will provide sufficient use of the increased rainfall. Application of this technical solution will provide the ability of the area to renew its natural functions with the distribution of rainfall and this will bring many economical and environmental benefits. The main benefits will be elimination of extreme weather changes and their consequences, strengthening the stock of water sources in the area, improving the soil fund and more equal distribution of rainfall through the year. The application of this technical solution will provide a decrease in the drainage of that excess water for which there is no room in the saturated soil and atmosphere via rivers into seas and oceans, i.e. water areas, soil saturated with water and vegetation play a basic role in the circulation of water on land.

What is claimed is:

1. The integrated technology system for improving the climate is created by one water reservoir block (1) which is connected to at least one bio-technical treatment block (3) and/or to at least one technical treatment block (2) which on one side is connected to at least one technical seepage block (21) which is connected to at least technical absorption block (22) and on the other side, it is connected to at least one technical drainage block (23) and, on the third side, is connected to at least one technical evaporating block (24) which is connected to water reservoir block (1), whilst at least one bio-technical treatment block (3) is, on one side, connected to at least one bio-technical seepage block (31) which is connected to at least one bio-technical absorption block (32) and, on the other side, it is connected to at least one bio-technical drainage block (33) and, on the third side, it is connected to at least one bio-technical evaporation block (34), which is connected to a water reservoir block (1).

2. In accordance with requirement 1, a property of the integrated technological system is that at least one technical treatment block (2) is connected to at least one bio-technical treatment block (3).
